(19) United States
(12) Patent Application Publication
(10) Pub. No.: US 2004/0046799 A1
(43) Pub. Date: Mar. 11, 2004

(54) Desktop manager

(76) Inventors: Bernd Gombert, Seefeld (DE); Bernhard von Prittwitz, Seefeld (DE)

Correspondence Address: Leopold Presser, Scully Scott Murphy & Presser, 400 Garden City Plaza, Garden City, NY, 11530, US

(21) Appl. No.: 10/433,514

(22) PCT Filed: Sep. 12, 2002
(86) PCT No.: PCT/EP02/10246

(30) Foreign Application Priority Data
Sep. 13, 2001 (DE) 10145185.7
Nov. 9, 2001 (DE) 10155030.8

(51) Int. Cl. G09G 5/00

(52) U.S. Cl. 345/781

(57) ABSTRACT

In a desktop manager program, it is possible to expand the graphical user interface (3) of conventional monitors and PCs by freely positioning the displayed sector of the user interface by means of a 3D input device (1, 1′) in such a way that the user can consequently determine himself the visible part of a user interface (3) of a monitor (6) and of a PC (4). Said visible part, a type of virtual window (2), can be selected with an input device (1, 1′) having at least three degrees of freedom. In this connection, two degrees of freedom serve to navigate a virtual window (2) on the user interface (3). A further degree of freedom is used to adjust an enlargement/reduction factor in regard to the objects on the user interface (3) inside the virtual window (2). It is consequently possible to define the virtual window only as a part of the entire display area of the display screen (6).

If the user interface (3) is then displayed on the display area of the display screen (6), the virtual window can be navigated via the user interface (3) by means of the input device as a type of “magnifying glass” with adjustable enlargement factor.

The present invention relates to a method for the management of user interfaces, to a computer software program for implementing such a method and also to the use of a force/moment sensor for such a method.

The general background of the present invention is the management of graphical user interfaces on which symbols are arranged, wherein the arrangement is as a rule freely selectable by the user. In this connection, in accordance with a definition, “desktop” is the designation for the visible working surface of the graphical user interface of, for example, Microsoft Windows or OS/2. “Desktop” normally therefore denotes a working area on the display screen that contains symbols and menus in order to simulate the surface of a desk. A desktop is, for example, characteristic of window-oriented programs such as Microsoft Windows. The purpose of such a desktop is the intuitive operation of a computer since the user can move the images of objects and start and stop tasks almost in the same way as he is used to with a real desk.

Since, in accordance with one aspect of the invention, a force/moment sensor is used as input device for such a desktop program, the prior art relating to force/moment sensors will be explained briefly below.

Force/moment sensors, which provide output signals in regard to a force/moment vector acting on them and, consequently, output signals in regard to various degrees of freedom that are independent of one another (for example, three translatory and three rotatory degrees of freedom) are known from the prior art. Further degrees of freedom can be provided by switches, small rotating wheels, etc. that are permanently assigned to the force/moment sensor.

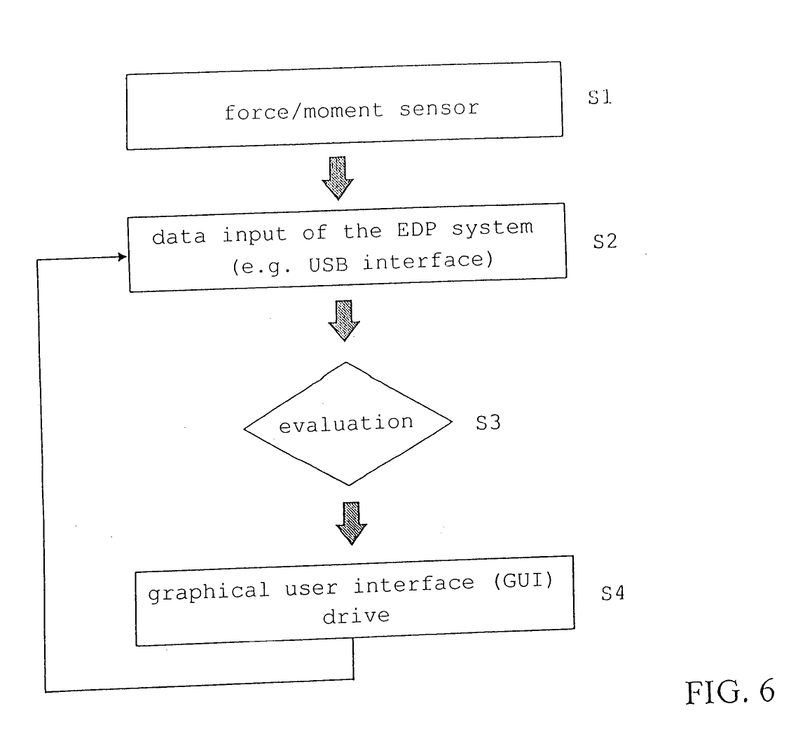

DE 199 52 560 A1 discloses a method for adjusting and/or displacing a seat in a motor vehicle using a multifunctional, manually actuated input device having a force/moment sensor. FIG. 6 of DE 199 52 560 A1 shows such a force/moment sensor. To this extent, reference is therefore made to said figure and the associated description of DE 199 52 560 A1 in regard to the technical details of such a sensor. In DE 199 52 560 A1, the input device has an operator interface on which a number of areas are provided for inputting at least one pressure pulse. The input device has a device for evaluating and detecting a pressure pulse detected by means of the force/moment sensor and converted into a force and moment vector pair. After such a selection of, for example, a seat to be controlled or a seat part of a motor vehicle, the selected device can then be linearly controlled by means of an analogue signal of the force/moment sensor. The selection of a function and also the subsequent control are therefore, in accordance with this prior art, separated into two procedures separated from one another in time.

From DE 199 37 307 A1, it is known to use such a force/moment sensor to control operating elements of a real or virtual mixing or control console, for example in order to create and to configure novel colour, light and/or sound compositions. In this connection, the intuitive spatial control can advantageously be transferred in three translatory and also three rotatory degrees of freedom for continuously spatially mixing or controlling a large number of optical and/or acoustic parameters. For the purpose of control, a pressure is exerted on the operator interface of the input device and a pulse is thereby generated that is converted into a vector pair comprising a force vector and a moment vector by means of the force/moment sensor. If certain characteristic pulse requirements are fulfilled in this connection, an object-specific control operation and/or a technical function may, for example, be initiated by switching to an activation state or terminated again by switching to a deactivation state.

Proceeding from the abovementioned prior art in regard to force/moment sensors and desktop programs, the object of the present invention is to develop desktop technology further in such a way that the management of user interfaces (desktop interfaces) can be configured still more intuitively.

This object is achieved according to the invention by the features of the independent claims. The dependent claims develop the central idea of the invention in a particularly advantageous manner.

The central insight of the invention is that a user of a real desk arranges various documents on the desk surface in accordance with an intuitive user-individual work behaviour. This aspect is already taken into account in conventional desktop technology, i.e. translated into the world of the graphical user interface.

In accordance with the present invention it is, however, possible for the first time to navigate a virtual window (like in the case of microfiche technology (microfilm having microcopies arranged in rows)) relative to a user interface. In order to remain with the microfiche analogy, the user interface can, so to speak, be moved, for example, in three dimensions underneath the virtual window.

In a desktop manager program according to the invention, it is consequently possible for the first time to extend the graphical user interface of conventional monitors by freely positioning the user interface in regard to the virtual window by means of a 3D input device in such a way that the user can consequently determine the visible part of a user interface of a monitor itself and/or its display scale.

Let it be pointed out yet again that, within the scope of the present description, the following definitions are taken as a base:

“User interface”:

Totality of the (virtual) area available to the user for arranging symbols

“Desktop”, “virtual window”:

Definable sector of the user interface shown on the monitor.

The user interface can therefore be greater than the desktop depending on the definition of the desktop. In this case, the entire user interface is not displayed on the monitor. However, it is also possible to make the size of the desktop equal to the entire user interface.

A further insight in the present invention is that the user first assumes a certain distance (“leaning back”) to gain an overview of the work place. After recognizing desired documents etc., by means of said overview, the focus is then directed at working documents of interest. In the case of the invention, this is achieved in that the magnification factor/reduction factor of a virtual window can be altered, which substantially corresponds to a zoom effect in regard to the objects situated within the window. Consequently, the focus of the viewer can be directed little by little at certain display screen objects (working documents, icons, etc.).

In accordance with the invention, this effect is achieved, stated more precisely, in that objects are, for example, first arranged by the user on a user interface. The user can therefore add, erase or move objects as known per se and also scale the display size of the objects.

This step corresponds to the arrangement, for example, of documents on a desk. In accordance with the invention, a virtual window having an adjustable magnification factor/reduction factor can be navigated in regard to the user interface, which corresponds to a focus that is variable in regard to position and viewing angle.

In this connection, it is particularly advantageous if an input device is used that provides drive signals in at least three mutually independent degrees of freedom. Consequently, navigation is possible that is three dimensional in regard to the user interface, wherein drive signals in two degrees of freedom can be used for positioning and the other drive signal can be used to adjust the enlargement factor/reduction factor (corresponding to an alteration in the visual angle of the focus).

Stated more precisely, in accordance with the present invention, a method is provided for the management of objects on a graphical user interface. The user first arranges objects on the user interface. Finally, a virtual window can be navigated in regard to the entire user interface configured in this way, wherein the content of the window is in each case displayed on the display screen.

As already explained above, it may be particularly advantageous to use an input device that generates drive signals in at least three degrees of freedom. In that case, drive signals in two degrees of freedom are used for positioning the virtual window in regard to the user interface and the drive signal in the third degree of freedom is used for the magnification/reduction function.

The input device may provide drive signals in at least three translatory and/or rotatory degrees of freedom. This input device may be, in particular, a force/moment sensor.

Alternatively, an input device for two-dimensional navigation (for example a computer mouse) may also be used to which an element is physically assigned for generating a drive signal in a third degree of freedom. Said element may, for example, be an additional switch, a rotating wheel or a key.

The virtual window may correspond to the entire display area of a display screen. Consequently, the size of all the objects on the entire user interface alters to the same extent when the zoom function is executed.

Alternatively, however, it is also possible to define the virtual window only as part of the entire display area of the display screen. If the entire user interface is then displayed on the display area of the display screen, the virtual window can be navigated by means of the input device as a type of “magnifying glass” having an adjustable enlargement factor in regard to the user interface so that, so to speak, the user interface can be traversed under the “magnifying glass”.

Software programs to be managed may be, in particular, office applications, such as, for example, word processing or tabular calculations. In that case, the objects on the user interface may be windows of files that are variable in regard to their display size. In that case, said files may be active, i.e. be displayed in a directly retrievable and executable state. After the activation of such an object, it is therefore not necessary to start an application program first.

The objects can be displayed in a pseudo 3D view on the user interface.

In the execution of the enlargement/reduction function (zoom function) of the object area, no navigation drive is necessary for the pointer mark.

In accordance with a further aspect of the present invention, a computer software program is provided that implements a method of the abovementioned type when it is running on a computer.

Finally, the invention proposes the use of a force/moment sensor for a method according to one of the abovementioned type.

Further features, advantages and characteristics of the present invention are now explained on the basis of exemplary embodiments and with reference to the figures of the accompanying drawings.

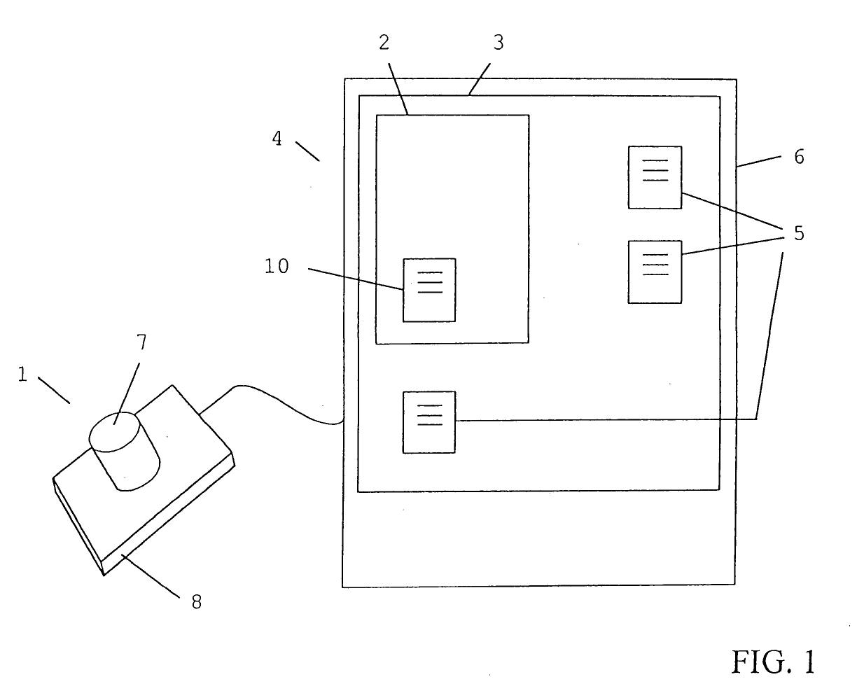

FIG. 1 shows a system having a 3D input device and a computer having a desktop interface, and

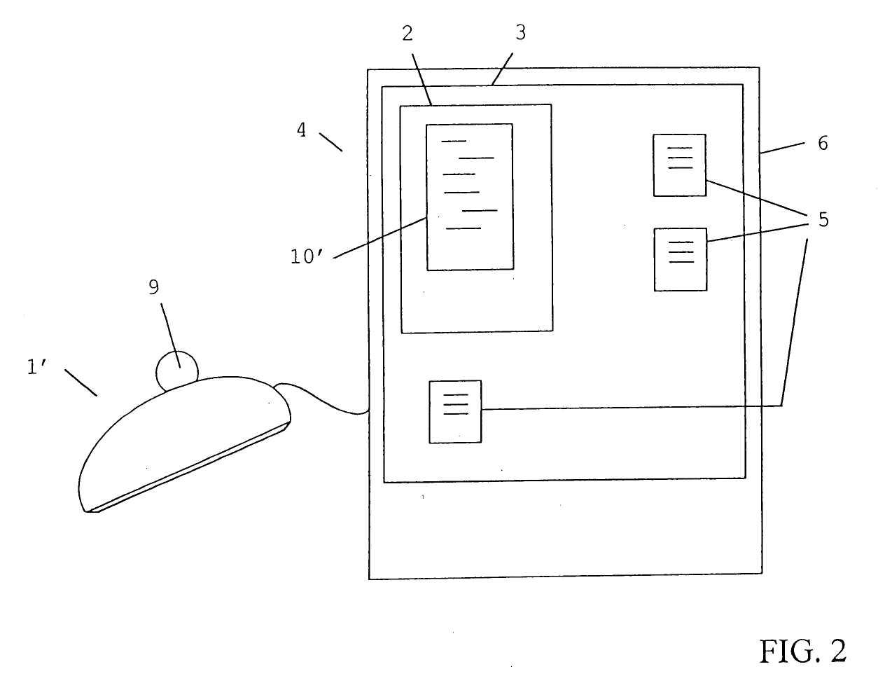

FIG. 2 shows a modification of the exemplary embodiment of FIG. 1 in which a display screen object is shown at the same time in an enlarged state (zoomed state),

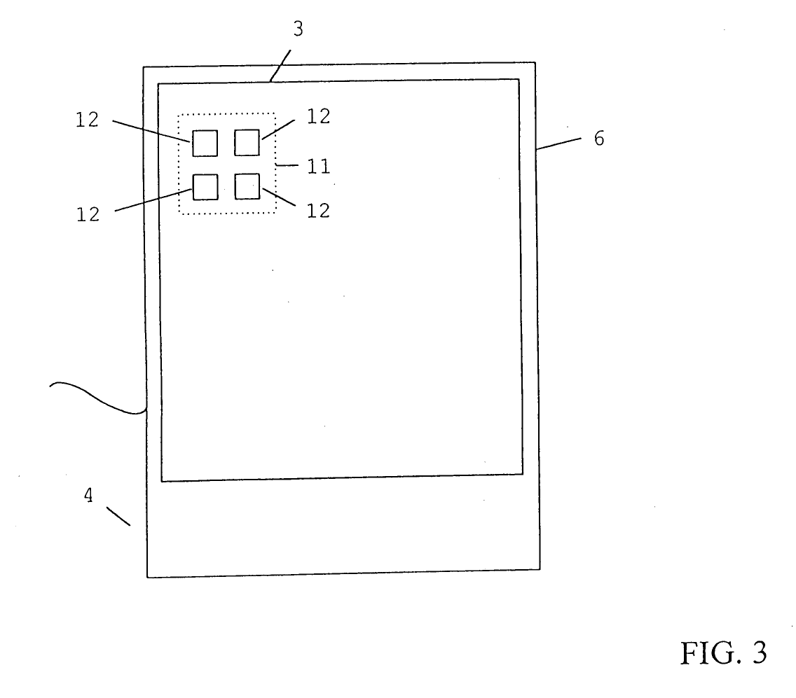

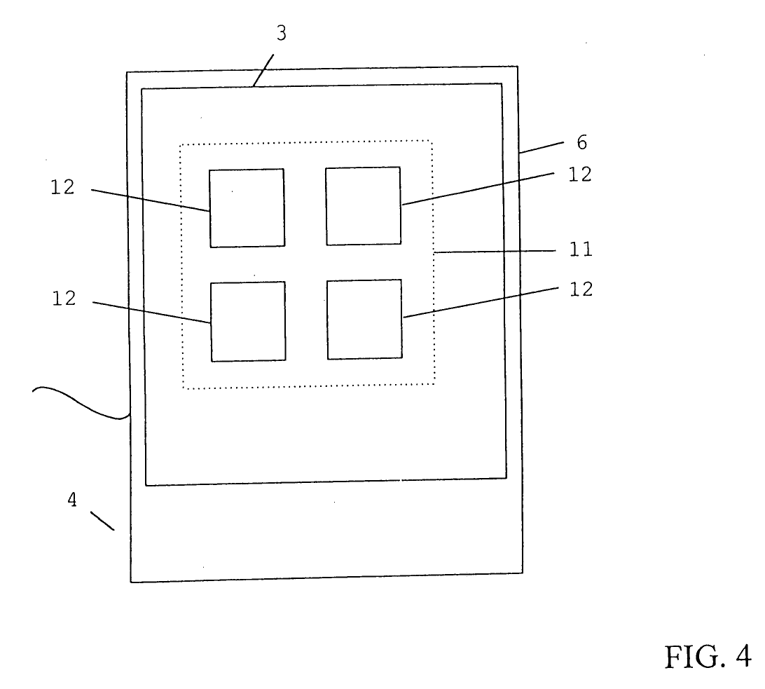

FIGS. 3 to 5 show a further exemplary embodiment in which a virtual window was defined as the entire display screen,

FIG. 6 shows a diagrammatic flow chart of a procedure for executing the present invention, and

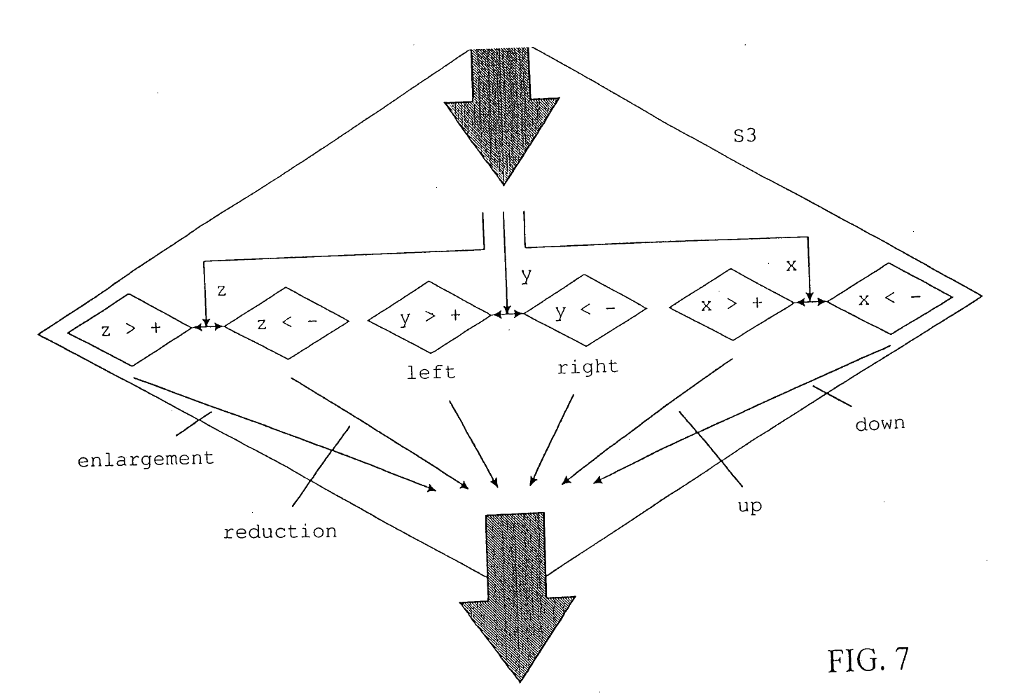

FIG. 7 shows the evaluation step S3 of FIG. 6 in detail.

As can be see in FIG. 1, a PC 4, for example, is used to implement the invention. Said PC 4 has a monitor 6 on which a desktop 3, that is to say a sector of the user interface, is displayed. A plurality of graphical objects 5, 10 are arranged on said displayed sector of the user interface.

A 3D input device 1 has an operating part 7 that is to be manipulated by the fingers or the hand of the user and that is mounted, for example, movably in three mutually independent rotatory degrees of freedom and three translatory degrees of freedom in regard to a base part 8. In this arrangement, a relative movement between operating part 7 and base part 8 is evaluated and the result of the evaluation is transmitted in the form of drive signals to the computer 4.

Let it be remarked that the input device 1 can, of course, also output drive signals in regard to further degrees of freedom by assigning further small rotating wheels, keys or switches physically to it, for example, on the operating part 7 or on the baseplate 8.

One aspect of the present invention is that a virtual window having adjustable size in regard to the entire area of the user interface can be navigated by means of the input device 1. In this connection, the display scale of the objects that are within the virtual window is optionally selectable in a particularly advantageous embodiment within certain limits by means of the input device 1.

Stated more precisely, drive signals in two degrees of freedom of the input device 1 are used to navigate the virtual window in regard to the user interface 3 (up/down or left/right). Finally, a drive signal in a third degree of freedom of the input device 1 is provided (if this option is provided) for the real-time adjustment of an enlargement/reduction factor for the objects situated within the virtual window.

In this connection, said enlargement/reduction factor can be continuously altered with suitable pixel scaling or, alternatively, altered discretely, for example, in the case of defined font size steps.

For example, the enlargement/reduction factor can be increased within the virtual window as a response to pressing (translation) or tilting (rotation) the operating part 7 of the input device 1 forward. Consequently, an intuitive hand/eye coupling takes place since this movement forward corresponds to an approach of the virtual window to the user interface 3, the display screen objects being displayed larger in accordance with the approach and that sector of the user interface 3 displayed on the display screen being, on the other hand, reduced.

In FIG. 1, such a virtual window is denoted by the reference symbol 2. As can be seen, the size of said window 2 is adjusted in such a way that it occupies only a part of the display area of the display screen 6. Accordingly, it is possible to navigate selectively, for example, as shown, via the object 10, so that the object 10 is situated within the window area. If the enlargement/reduction factor of the virtual window 2 is now increased by means of the input device 1, which can take place in steps or continuously, the enlarged display 10′ of the object 10 occurs that can be seen diagrammatically in FIG. 2.

In FIGS. 3 to 5, on the other hand, the case is shown where the virtual window 2 is adjusted in such a way that it corresponds to the entire display area of the display screen 6. In navigating the virtual window 2, the user interface 3 is consequently moved in regard to the desktop.

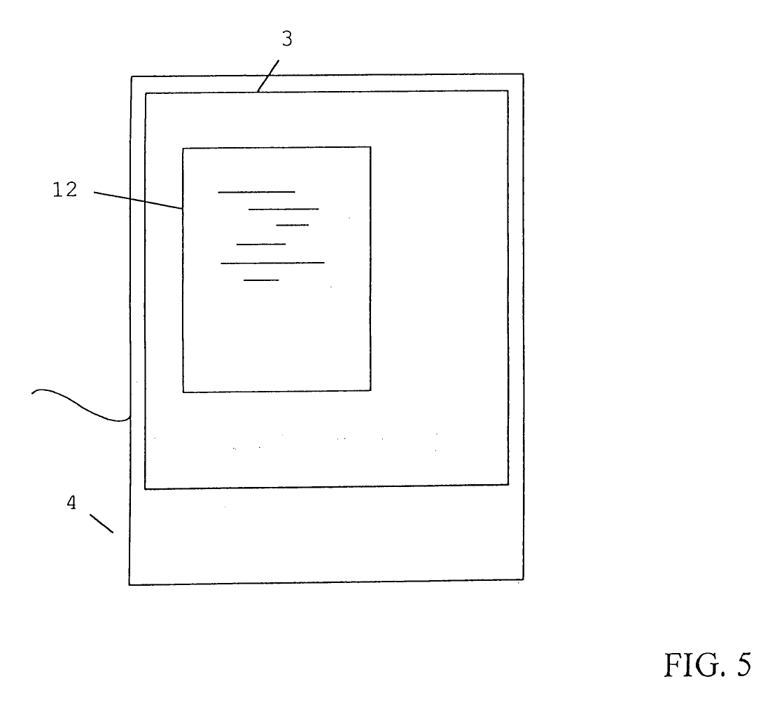

In the preferred embodiment, in which an enlargement/reduction factor can be selected for the virtual window, the display size of all the objects displayed on the display area alters if the enlargement/reduction factor is altered. If the user has arranged a group 11 on the user interface 3, he can enlarge the display of said group continuously (pixel scaling) or in steps until, for example, only the document 12 is displayed legibly in said group 11 (see FIG. 5). This corresponds to zooming in on the user interface 3.

In contrast to FIG. 1, a computer mouse 1′ is symbolically provided as input device in FIG. 2. Physically assigned to said computer mouse 1′, which can in fact actually provide only drive signals in two degrees of freedom (x-y-axis), is a further element 9 that can generate a drive signal in at least one further degree of freedom. In the case shown, said further element is a small rotating wheel 9 that is arranged on the top of the computer mouse 1′. The display area of a display screen object 10, 10′ can, for example, also be enlarged (selective focus) or all the display screen objects 5, 10 can be shown in enlarged form (general focus) by rotating said wheel 9 forwards.

Correspondingly, the reduction function can take place by rotating the wheel 9 in the backward direction (in the case of the three-dimensional input device by pressing or tilting the operating part 7 backwards), which corresponds intuitively to the user leaning backwards in order to obtain a better overview of the objects 5, 10 on the user interface 3.

For the case where the objects 5, 10 on the user interface 3 reproduce files of application programs, such as, for example, word processing or tabular calculations, said file objects can be displayed actively. This means that, in the case of an enlargement/reduction action on the corresponding object, not only an icon, for instance, as a symbol of the corresponding application program is displayed in enlarged or reduced form, but, on the contrary, the document/the tabular calculation can itself be enlarged or reduced. Accordingly, a plurality of display screen objects can also be displayed actively on the user interface 3 at the same time, their respective display scale being freely selectable. Consequently, the user can arrange, for example, documents in any size and at any position on the display screen surface 3.

FIG. 6 shows diagrammatically the procedure for executing the present invention. Output signals of the force/moment sensor are generated in a step S1. These are then fed (step S2) to the data input of an EDP system. This may take place, for example, by means of a so-called USB interface. USB (universal serial bus) is a connection (port) for peripheral devices (such as mouse, modem, printer, keyboard, scanner, etc.) on a computer. Advantageously, the transfer rate of USB in the 1.1 version is already 12 MBit/s.

The signals inputted by the force/moment sensor are evaluated in a step S3. Said step S3 is explained in detail below with reference to FIG. 7.

Depending on the evaluation in step S3, graphical user interface (GUI) drive takes place in a step 4 before the data of the force/moment system are evaluated again.

Referring to FIG. 7, the step S3 of the procedure in FIG. 6 will now be explained in greater detail. As can be seen in FIG. 7, for example, data in three different degrees of freedom x, y and z are evaluated as to whether the corresponding signal is in the positive or negative range. In regard to the degree of freedom “z”, a positive signal can be used for the purpose of enlargement and a negative signal for the purpose of reduction of the virtual window in regard to the totality of the graphical user interface.

In regard to the degree of freedom “y”, a positive signal can effect a movement of the virtual window to the left and a negative signal a movement of the virtual window to the right (always in regard to the totality of the graphical user interface).

This is, of course, equivalent to the respective inverse movement of the user interface “underneath” the virtual window. The virtual window may therefore be, for example, designed as a fixed highlighting bar “underneath” which the user interface is navigated across. Objects that come underneath the virtual window in this process are automatically marked (“highlighted”) and preselected for possibly being clicked on subsequently or other activation. This procedure is advantageous, in particular, if a directory structure (directory tree) is navigated underneath the fixed window, directories situated underneath the window automatically being selected. Consequently, in principle, it is possible to navigate in infinitely large structures without the user's hand having to leave the input device. “Changing one's grip” to alter the picture sector as soon as the cursor reaches the edge of the display screen in the case of the known art is no longer necessary.

Finally, in regard to the degree of freedom “x”, a positive signal can effect a movement of the window upwards and a negative signal a movement of the window downwards. This can also be seen analogously as inverse movement of the user interface “underneath” the virtual window.

The advantages of the invention compared with the prior art will be briefly cited yet again below. Current desktop programs offer, on the other hand, only a working area that is defined by means of the display screen size and the window size of the relevant application. Accordingly, the sole degree of freedom of current desktop programs is to design so-called icons as links to documents and to be able to arrange programs and other contents freely on the desktop.

However, in the case of the present invention, the display size or the document size on the user interface can be freely selected. The arrangement as well as the dimensional display of the display screen objects on the desktop surface can therefore then be freely chosen by means of a single device, such as, for example, a 3D input device or a 2D input device with additional elements. Accordingly, the recognition value of freely arranged areas is substantially greater since, in this case, optical recognition features and not just purely memory features apply. Consequently, in accordance with the present invention, a real intuitive working behaviour is largely achieved. The real working behaviour is, in fact, usually that the user works at the work place using the visually perceptible sector. Focusing on a working document, and leaning back to obtain an overview are, of course, part of the processing of real objects. However, the present invention now makes it possible for the first time to transfer such an intuitive behaviour also to virtual objects, namely objects displayed on a user interface.

In a desktop manager program, it is consequently made possible to expand the graphical user interface 3 of conventional monitors and PCs by freely positioning the displayed sector of the user interface 3 by means of a 3D input device 1, 1′ in such a way that the user can himself consequently determine the visible part (“virtual window”) of the user interface 3 of a monitor 6 and of a PC 4.

1. Method for the management of a graphical user interface (3) on which it is possible to navigate by means of an input device (1, 1′), wherein the method comprises the following steps:
arrangement of graphical objects (5) on the user interface (3),
navigation of a virtual window (2) in regard to the user interface (3), wherein the navigation takes place by means of drive signals from the input device (1, 1′), and
display of that sector of the user interface (3) situated in the virtual window (2).

2. Method according to claim 1, characterized in that an enlargement/reduction factor can be adjusted by means of the input device (1, 1′) for objects situated inside the virtual window (2).

3. Method according to claim 1 or 2, characterized in that the navigation and, optionally, the adjustment of the enlargement/reduction factor takes place substantially in real time.

4. Method according to any one of the preceding claims, characterized in that drive signals are generated by means of the input device (1, 1′) in at least three degrees of freedom, wherein drive signals in two degrees of freedom are used for the navigation of the virtual window (2) in regard to the user interface (3), and the drive signal in the third degree of freedom is optionally used to adjust the enlargement/reduction factor.

5. Method according to claim 4, characterized in that the input device (1) provides drive signals in at least three translatory and/or rotatory degrees of freedom.

6. Method according to claim 5, characterized in that the input device is a force/moment sensor (1).

7. Method according to claim 1 or 2, characterized in that an input device (1) for two-dimensional navigation such as, for example, a computer mouse, is used to which an element (9) is physically assigned for generating a drive signal in a third degree of freedom.

8. Method according to any one of the preceding claims, characterized in that the size of the virtual window (2) is adjustable.

9. Method according to claim 7, characterized in that the virtual window (2) is defined as part of the entire display area of the display screen.

10. Method according to any one of claims 1 to 9, characterized in that the virtual window (2) corresponds to the entire display area of a display screen.

11. Method according to claim 9, characterized in that the virtual window can be navigated via the user interface (3) by means of the input device (1, 1′) as a type of “magnifying glass” having an adjustable enlargement/reduction factor.

12. Method according to any one of the preceding claims, characterized in that the software programs are office applications, such as, for example, word processing or tabular calculations, and the objects on the user interface (3) are windows (5, 10, 10′) of files that can be altered in regard to their display size.

13. Method according to claim 12, characterized in that the files are displayed actively, i.e. in a directly executable state.

14. Method according to any one of the preceding claims, characterized in that the objects on the user interface (3) are displayed in a pseudo 3D view.

15. Method according to any one of the preceding claims, characterized in that the enlargement/reduction of an object is executed in the form of a zoom effect.

16. Method for the management of a desktop, characterized in that the graphical user interface (3) of a monitor (6) is expanded by the free positioning of the user interface (3) by means of a 3D input device (1, 1′) in such a way that the user can himself consequently determine the visible partial sector of a user interface (3) of the monitor (6) by actuating the 3D input device (1, 1′).

17. Computer software program, characterized in that it implements a method according to any one of the preceding claims if it is running on a processor-controlled device (4).

18. Use of a force/moment sensor for a method according to any one of claims 1 to 16.
